(19) United States
(12) Patent Application Publication
(10) Pub. No.: US 2014/0327613 A1
(43) Pub. Date: Nov. 6, 2014

(54) IMPROVED THREE-DIMENSIONAL STEREOSCOPIC RENDERING OF VIRTUAL OBJECTS FOR A MOVING OBSERVER

(71) Applicant: UNIVERSITA' DEGLI STUDI DI GENOVA, Genova (IT)

(72) Inventors: Manuela Chessa, Genova (IT); Fabio Solari, Sestri Levante (IT); Matteo Garibotti, Genova (IT); Silvio Paolo Sabatini, Genova (IT)

(73) Assignee: UNIVERSITA' DEGLI STUDIDI GENOVA, Genova (IT)

(21) Appl. No.: 14/364,598

(22) PCT Filed: Dec. 13, 2012
(86) PCT No.: PCT/IB2012/057284

§ 371 Date: Jun. 11, 2014

(30) Foreign Application Priority Data
Dec. 14, 2011 (IT) TO2011A001150

(51) Int. Cl. G06F 3/01; G06T 19/00; G06T 15/08

(52) U.S. Cl. CPC G06F 3/011; G06F 3/013; G06F 3/012; G06T 15/08; G06T 19/006; G06T 2200/04; G06T 2215/16
USPC 345/156

(57) ABSTRACT

A system is for three-dimensional stereoscopic rendering of virtual objects in a scenario by a display screen (S) with respect to which an observer (O) can move. The system overcomes the problems of incorrect perception of three-dimensionality which are present in prior art stereoscopic rendering systems. The system includes a device (20) adapted to detect the coordinates of the respective observation position (O^{L,R}) in a predetermined reference system related to the screen (S), by computing (estimating) the positions of the observer's eyes, and includes a processing unit (10) adapted to generate, for each object point (T), a pair of corresponding image points (tᵢ^{L,}tᵢ^{R}) on the screen (S), which are selectively visible to the observer (O) and are related to the detected current observation position (Oᵢ^{L,R}).

The present invention relates in a general way to the stereoscopic rendering of three-dimensional images, and more particularly to augmented reality or virtual reality systems comprising a human-machine interface capable to provide a stereoscopic rendering of virtual objects in a virtual or real scenario, without distortion.

Specifically, the invention relates to a system and a method for three-dimensional stereoscopic rendering of virtual objects in a virtual or augmented reality scenario by means of a display screen with respect to which an observer can move and/or change his position and/or the orientation of his head, according to the preambles of Claims 1 and 7 respectively.

In recent years there has been a growing interest in technologies for rendering three-dimensional (stereoscopic) images, particularly for the representation of virtual reality or augmented reality scenarios, for professional applications such as visualization in the scientific or medical fields, or for entertainment applications such as three-dimensional cinematography and video games set in virtual reality environments.

In the field of three-dimensional cinematographic representation, intrinsically three-dimensional image data are acquired from a pair of filming devices placed side by side at a distance corresponding to the interocular distance of an observer. The perception of three-dimensional images can therefore be achieved by using display technologies which have been known for decades, for example by alternately displaying the images taken by two video cameras and using appropriate active spectacles that obscure the image reaching the observer's right and left eyes alternately.

In the field of rendering of artificial scenarios, for example in the case of virtual reality in which an environment is entirely reconstructed by a computer, or in the case of augmented reality in which a computer reconstructs artificial images located in the real environment in which the observer acts, the three-dimensional images are generated by a processing unit which operates as virtual stereoscopic cameras.

The recent diffusion of three-dimensional stereoscopic content has led to the development of routinely used devices for the visualization of these data. This has opened the way to powerful human-machine interaction systems based on augmented reality environments, in which a person can interact with both virtual and real environments and tools.

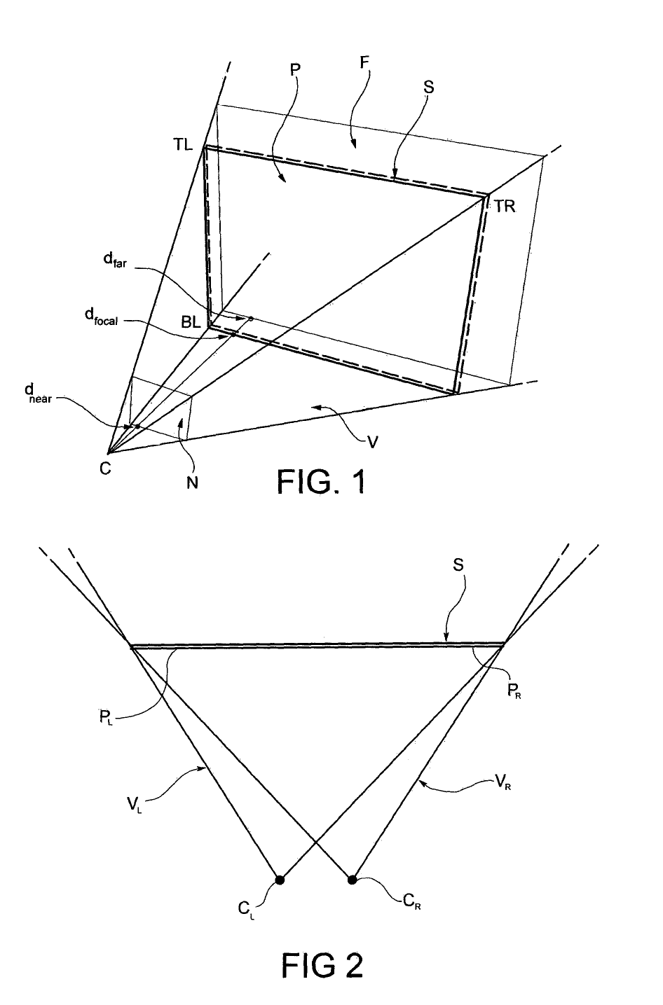

With reference to FIG. 1, which shows a virtual filming geometry and the corresponding three-dimensional area visible on a screen S, a virtual camera C has a field of view defined by a view volume V which has the general shape of a truncated pyramid (frustum) V, described by the size of the focal plane (or projection plane) P (which may coincide with S) and by the distance between the virtual camera C and the focal plane P. Typically, the focal plane or projection plane P is rectangular, regardless of whether it defines a congruent projection area or circumscribes a projection area of complex shape within itself. The virtual camera C is positioned at the vertex of the view volume V of truncated pyramidal shape, and the far plane F is positioned at the base of this volume, which is at a distance d_{far} from C. A near plane N, at a distance dₙₑₐᵣ from C, is also defined. The far plane and the near plane are well known in 3D computer graphics, where they are used to define the truncated pyramid (frustum) comprising the objects to be rendered, and they will not be described further in this text. The intermediate focal plane P, also known in 3D computer graphics, is located at a distance d_{focal} from C and is completely described by three points, for example, as shown in the drawing, a top left vertex TL, a bottom left vertex BL and a top right vertex TR, which are the intersections of the focal plane or projection plane with the straight lines originating from the projection centre C of the virtual camera.

In order to render a three-dimensional scene stereoscopically, it is common practice to use the method known as “parallel axis asymmetric frustum perspective projection” or “off-axis technique”, which allows a human observer to perceive depth. Stereo images are obtained by projecting the virtual objects in the scene on to the projection plane for each of the two virtual cameras. The projection plane has the same position and the same orientation for both virtual cameras, as shown in FIG. 2 (which is a simplified, two-dimensional representation of the three-dimensional view volumes, one of which is shown in FIG. 1). A left virtual camera C_{L} and a right virtual camera C_{R} are positioned side by side, being separated by a predetermined distance or baseline, generally corresponding to the average interocular distance of an observer, and have asymmetric view volumes V_{L}, V_{R}, respectively, which define a left focal plane P_{L} and a right focal plane coinciding with each other.

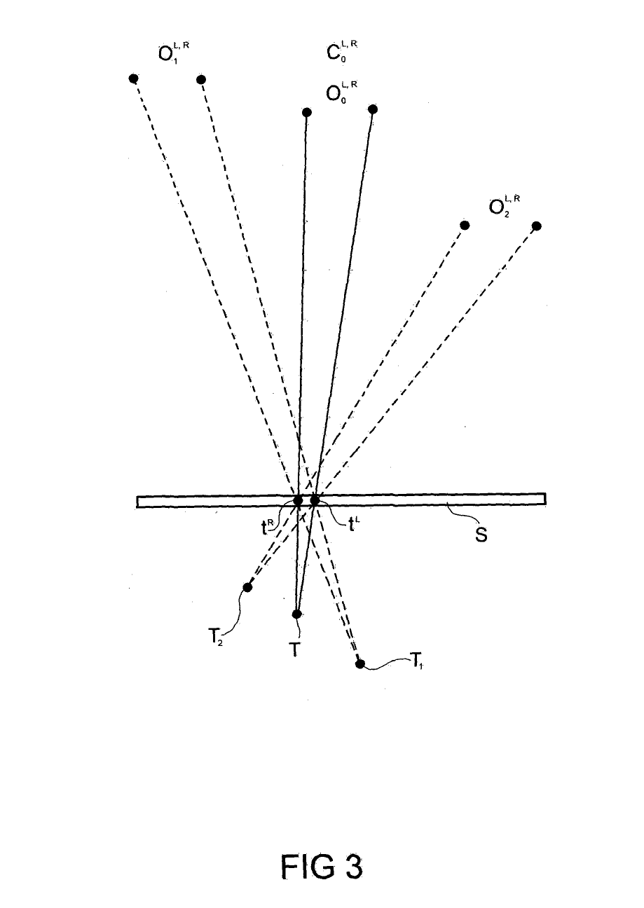

FIG. 3 is a schematic representation of the geometry of a virtual reality environment (a term which is used below to signify either a virtual reality scenario or an augmented reality scenario) for the stereoscopic rendering of virtual objects.

The letter S indicates the screen or projection plane of the images, which are generated artificially by a processing unit adapted to control the light emission of the individual display elements of an active screen, or are projected by projector means associated with a passive screen.

A virtual object point T is represented on the screen S by a pair of corresponding projections or image points t^{L} and t^{R}, on the left and on the right respectively, generated by a (virtual) stereoscopic cameras located in the pair of positions defined jointly as C₀^{L,R}.

A real observer O, whose eyes O₀^{L,R} are located in the same position as the (virtual) cameras C₀^{L,R} (that is to say, whose eyes are located in the same positions as the virtual stereoscopic cameras) perceives the object T correctly, according to the lines of sight shown in solid lines. If the same observer moves, or rotates his head, in the space in front of the screen S, with his eyes in the positions O₁^{L,R} or O₂^{L,R} (thus changing the direction of observation), he will perceive the object T in incorrect positions, namely T₁ or T₂ respectively, according to the lines of sight shown in broken lines.

Consequently, it is essential for the observer to be in the same position as the virtual stereoscopic camera when observing a virtual scene, in order to have a veridical perception of a three-dimensional scene and of the shape and depth of the objects populating it. It is only in this case that the images formed on the observer's retinas, as a result of the observation of the stereoscopic display, are identical to the images that would have been created by observation of an equivalent real scene.

If this constraint is not met, the observer perceives a distortion of the shape and depth of the objects and of the reconstructed scene as a whole. This is particularly important in augmented reality applications in which the observer perceives real and virtual stimuli simultaneously, and in which, therefore, the rendering of the three-dimensional data must not introduce undesired distortions.

Patent application WO 2010/062601 describes a system for tracking an observer's head. The possible applications referred to include motion parallax, but the problems of stereoscopic rendering in the manner described by the present invention are not tackled.

Patent application WO 2006/081198 describes a system for tracking an observer's head, but not his eyes. Moreover, this does not tackle the problems relating to the correct perception of stereoscopy.

Patent application GB 2477145 describes a system for accurately tracking the position of an observer's eyes, but the problem of correctly generating the stereoscopic images as a function of the position of the eyes is not tackled.

Patent application US 2011/0228051 describes a system for manipulating stereoscopic images in video sequences based on an estimate of the gaze direction. However, this method does not overcome the problems of correct perception of three-dimensional stimuli.

Patent application US 2005/0264559 describes a specific solution for the presentation of three-dimensional stimuli which is applied to a suitably designed display system. However, this solution does not overcome the theoretical problem in a general manner and cannot be applied to common stereoscopic display systems.

Patent application US 2005/0253924 describes a system for varying the viewing parameters of virtual cameras in the method of stereoscopic display (the off-axis method) according to the prior art. The problems of correct perception of the three-dimensional stimuli to which the present invention relates are not tackled.

Japanese patent application 6187424 filed by Sun Microsystems Inc. concerns a method and equipment for generating stereoscopic images with tracking of an observer's head movements. This document takes account of the fact that the observer's viewpoint relative to a projection screen may change, and in order to avoid this difficulty the invention teaches the selection of viewpoints from a limited set of predetermined positions, but without proposing an effective general solution to overcome the distortion of the structure of the virtual scenes and the consequent incorrect evaluation of the distances and shapes in these scenes by an observer moving freely in the whole space in front of a three-dimensional screen.

The tracking of the observer's head position, and the consequent modification of the position of the virtual stereoscopic camera, using methods which can easily be deduced from the prior art, fails to resolve this problem.

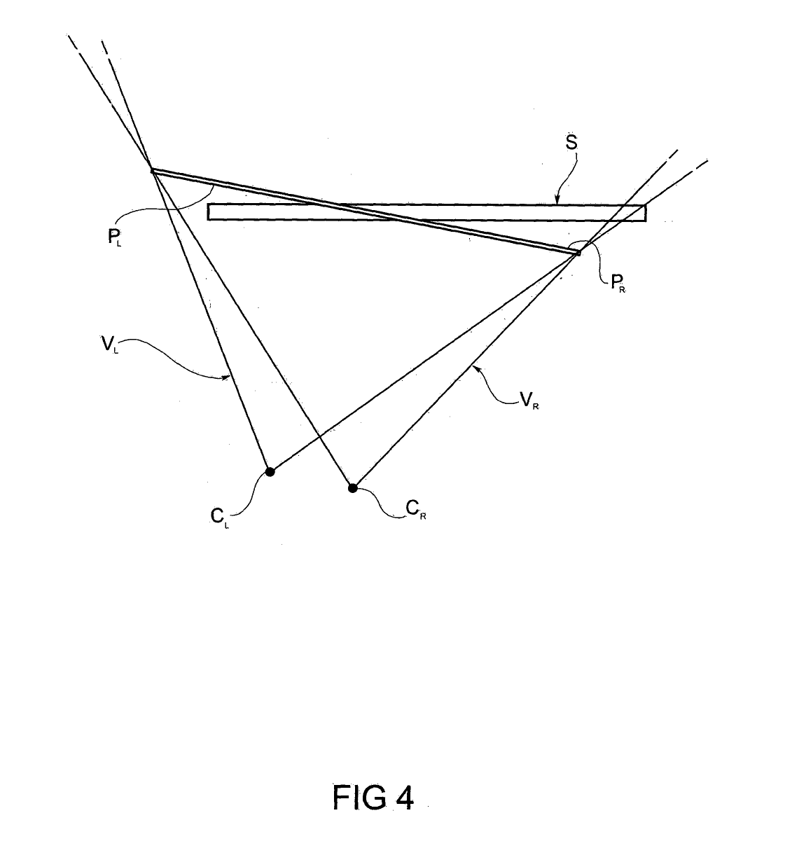

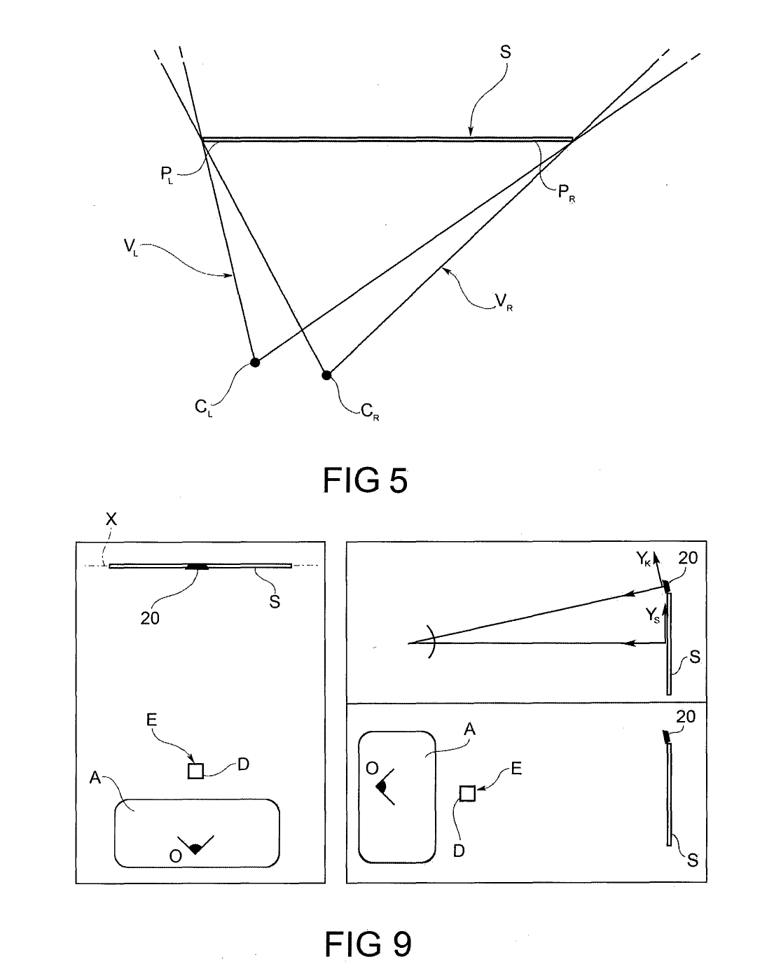

If the observer moves in front of the screen, the prior art systems which estimate the position of his eyes, by tracking the position of his head for example, perform a roto-translation of the virtual cameras according to the detected position of the observer. However, this solution, shown in FIG. 4, is not optimal, because the left and right focal planes P_{L} and P_{R}, which always coincide with each other, cease to coincide with the screen, and therefore the virtual reality scenario which is rendered ceases to be consistent with a realistic representation, and the observer again perceives the depth and the structure of the three-dimensional scene erroneously.

In the final analysis, this solution is an approximation, which may be acceptable if the movements of the observer's head are small, but is inadequate if the person is moving in a larger space. This solution is also inadequate for simple rotations of the head.

Because of this aspect, as mentioned above, it is impossible to achieve the desired degree of realism in entertainment systems, and it is impossible to make realistic and accurate quantitative evaluations with scientific instruments using technologies based on stereoscopic display systems for rendering three-dimensional data.

In entertainment and video game applications, the perceived distortions can cause eye strain. The effects of these distortions are critical in medical applications such as surgical applications or cognitive rehabilitation systems and applications for studying visual-motor coordination.

The object of the present invention is therefore to provide a method for rendering augmented reality or virtual reality scenarios which can correctly render three-dimensional virtual objects for an observer who is active in the virtual scenario and who changes his position and/or direction of observation, particularly the position of his head and eyes, in the real environment in front of the projection screen, in order to provide the benefit of the most natural possible interaction with a virtual environment, without constraints on the observer's position or movement.

According to the present invention, this goal is achieved by means of a system and a method for three-dimensional stereoscopic rendering of virtual objects having the characteristics claimed in Claims 1 and 7 respectively.

Specific embodiments are described in the dependent claims, the content of which is to be considered as an integral part of the present description.

The invention further proposes a computer program or group of programs comprising one or more code modules for implementing the method proposed by the invention and a computer program product, as claimed.

Briefly, the invention is based on tracking the current position of an observer in the space in front of the display screen for the purpose of determining the correct virtual observation points corresponding to the position of the observer's eyes, and using the respective view volumes to compute the correct corresponding stereoscopic projections of the virtual object points on the screen. This enables the positions of the three-dimensional virtual objects to be perceived in a correct and natural manner.

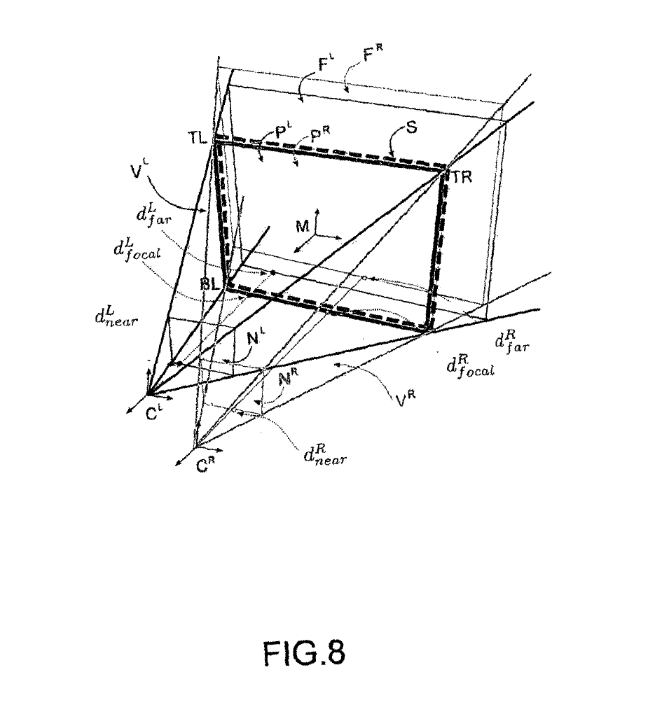

More specifically, as shown in the schematic illustration in FIGS. 5 and 8 of the regenerated asymmetric view volumes with respect to the observer's position, the positions of the observer's eyes are calculated, according to the invention, on the basis of data acquired by off-the-shelf position detector devices, and these data are used in a recurrent manner to regenerate the left and right images projected on the screen. This is done by using two generalized asymmetric view volumes (different from the off-axis volumes of the prior art), denoted by V_{L} and V_{R} respectively, of the virtual cameras, denoted by C_{L} and C_{R}, these volumes originating from positions coinciding with the detected positions of the observer's eyes, and having focal planes P_{L} and P_{R} coinciding with the projection screen S, thus overcoming the problems arising from the simple roto-translation of the virtual stereoscopic cameras according to the prior art (the off-axis method).

Advantageously, the observer's position in the space in front of the screen is detected periodically at predetermined time intervals, or is triggered by an event in the form of a movement of the observer or of his head.

Further characteristics and advantages of the invention will be disclosed more fully in the following detailed description of one embodiment of the invention, provided by way of non-limiting example, with reference to the attached drawings, of which:

FIGS. 1 to 5 have been discussed in the introductory part of this description;

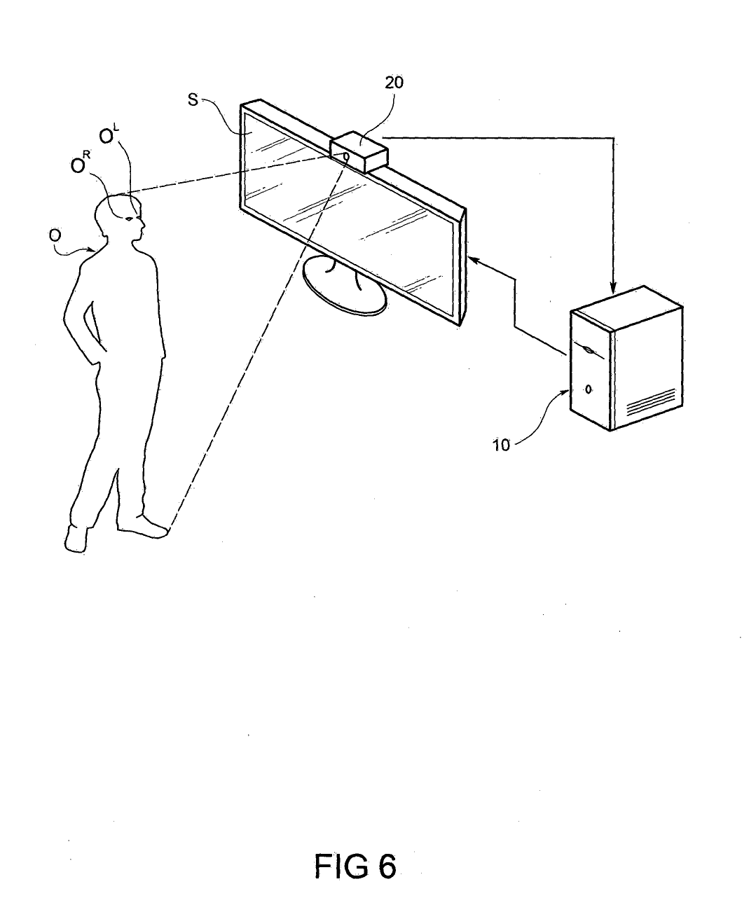

FIG. 6 is a general illustration of a system for three-dimensional stereoscopic rendering of virtual objects for a moving observer located in front of a display screen;

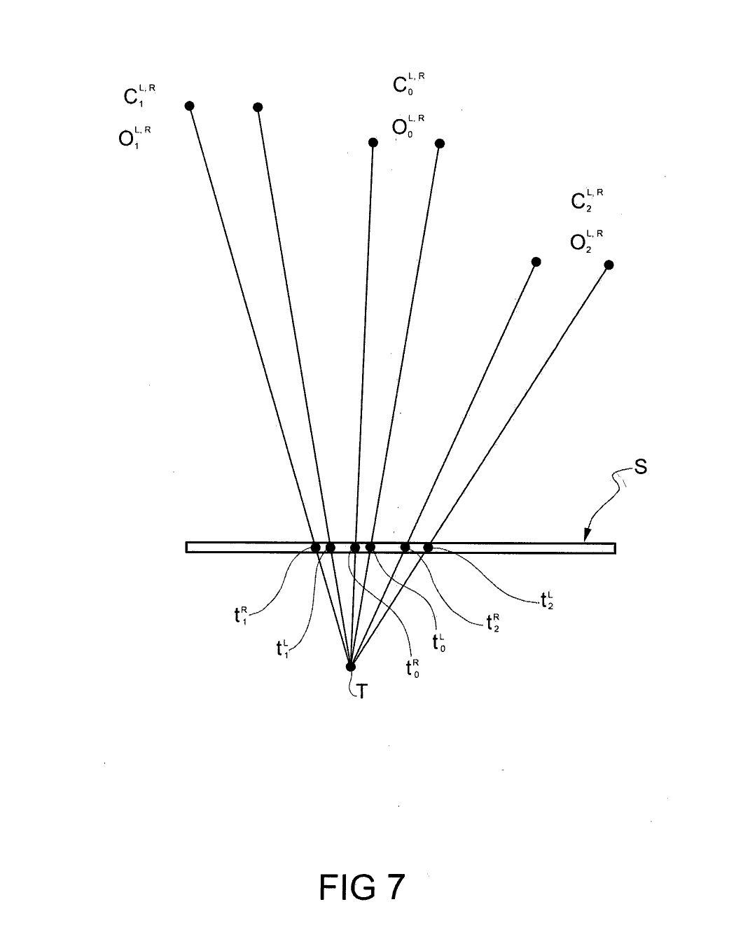

FIG. 7 is a schematic illustration of the geometry of a stereoscopic virtual reality environment according to the invention;

FIG. 8 is a schematic illustration of the generalized asymmetric view volumes according to the invention;

FIG. 9 is a schematic illustration of an experimental set-up used to test the system according to the invention; and

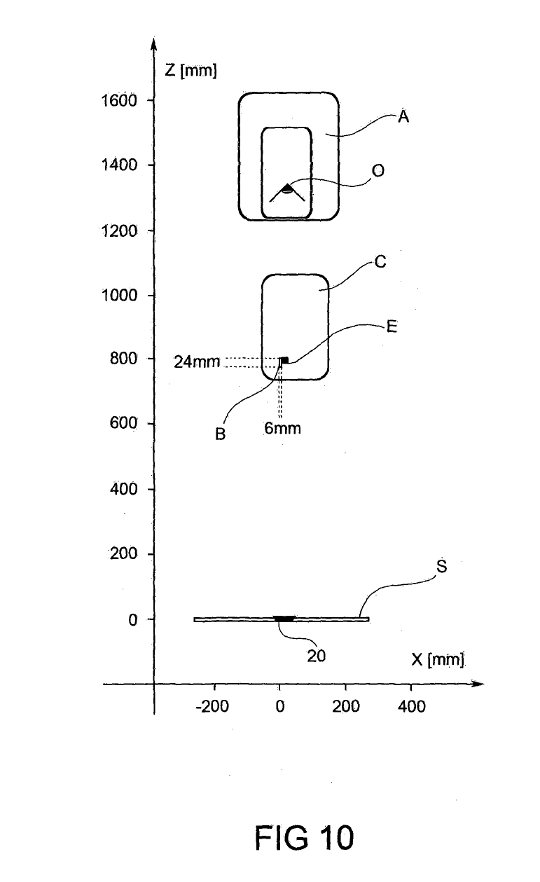

FIG. 10 is an illustration of the experimental results obtained for the system according to the invention.

With reference to FIG. 6, this shows the essential features of a system for the stereoscopic rendering of a virtual reality or augmented reality environment or scenario, using a display screen with respect to which an observer O can move and/or can change the position of his eyes O^{L} and O^{R}.

The system comprises a workstation 10 adapted to generate three-dimensional images of augmented reality or virtual reality environments on at least one environmental projection screen S, for example an environmental single screen or multi-screen system. These screens may be active screens, surfaces on which images are projected, or auto-stereoscopic screens.

The workstation 10 is associated with detector means 20 for measuring the position of an observer O, particularly the position of his head, and even more preferably the position of the observer's eyes O^{L} and O^{R}, for example detector means comprising a filming device in the visible band and an infrared depth sensor, adapted to detect the position and movement of a person (or of a device worn by a person) in a predetermined coordinate system.

An example of a workstation which may be used is a personal computer with an Intel Core i7 processor operating at 3.07 GHz, 12 GB of RAM, a 1000 GB hard disc drive, and a Nvidia Quadro 2000 graphic engine with 1 GB of RAM, designed to generate stereoscopic images at the frame rate of 120 Hz.

The screen which is used may be a commercial 3D monitor such as an Acer HN274H 27-inch monitor.

The detector device used may be a commercial device, such as the Xbox Kinect device produced by Microsoft for the Xbox360 games console.

The workstation is designed to run a program or group of programs which are stored on a hard disc drive or accessible on a communications network (not shown) and are adapted to provide instructions for implementing a rendering method according to the invention, which will be detailed subsequently.

The system according to the invention further comprises a storage memory subsystem, of a known type, integrated with the workstation 10 or connected thereto by means of the network connection, and adapted to store databases of predetermined three-dimensional models, images, or sequences of images.

The system may also be arranged for connection to other local or remote peripheral input/output devices, or may be composed of other computer system configurations, such as a multiprocessor system or a computer system of the distributed type, where the tasks are executed by remote computer devices interconnected by a communications network and the modules of the program can be stored in both the local and the remote storage devices.

The embodiments of the invention further comprise a computer program (or group of programs or program modules), in particular a computer program which can be archived on or in a data carrier or memory, including one or more code modules containing instructions for implementing a rendering method according to the invention. The program may use any programming language, and may be in the form of source code, object code or an intermediate code between source and object code, for example in a partially compiled form, or in any other desired form for implementing the method according to the invention.

Finally, the invention further proposes a computer program product, which may be a storage medium which is readable by a computer and which stores a computer program or group of programs including instructions for executing the rendering method according to the invention.

Specific examples (in a non-exhaustive list) of a computer-readable storage medium are any object or device capable of storing a program or a program module, such as a random access memory, a read-only memory, a compact disc memory, or a magnetic recording medium or a hard disc. More generally, the computer program product may also be in the form of a data stream readable by a computer system, which encodes a program of computer instructions, and which can be carried, for example, on a geographic communications network such as the Internet.

The solutions referred to here are considered to be well known in the art and will not be described further here, since they are not in themselves relevant for the purposes of the application and comprehension of the present invention.

With reference to FIG. 7, this shows in a schematic manner the geometry of the stereoscopic rendering of a virtual reality environment according to the approach proposed by the invention, which differs from the prior art shown in FIG. 3. A virtual stereoscopic camera located at C₀^{L,R} (where L,R denote the positions of the left and right cameras) computes the left and right projections t₀^{L} and t₀^{R} of a virtual object point T on the projection screen or plane S. An observer whose eyes O₀^{L,R} are located in the same position as the virtual camera perceives the object T in a position coinciding with its real position.

An observer whose eyes are located in a different position Oᵢ^{L,R}, for example O₁^{L,R} or O₂^{L,R}, still perceives the object T in its real position, and therefore correctly perceives its three-dimensional shape, because an associated pair of stereoscopic images tᵢ^{R},tᵢ^{L} (t₁^{R},t₁^{L} and t₂^{R},t₂^{L} respectively) is generated with respect to his position, these images being determined on the basis of the updated positions of the virtual cameras Cᵢ^{L,R} (C₁^{L,R} and C₂^{L,R}).

The observer's movements are compensated by measuring (estimating) the positions of his eyes and placing the virtual cameras in the same positions, the corresponding generalized asymmetric view volumes V_{L}, V_{R}, updated as a function of the detected position of the observer, being calculated for these cameras, subject to the requirement that the respective focal planes or projection planes P_{L}, P_{R} must always coincide with the display screen, as shown in FIG. 5 (which is a simplified two-dimensional illustration of the three-dimensional view volumes, shown for completeness in FIG. 8).

Thus the virtual reality environment which is generated is at all times a virtual replica of the real representation.

This operation is performed by means of the following calculations, which are not implemented in the prior art systems.

With reference to FIG. 8, we shall consider a focal plane described by the parameters ^{M}TL, ^{M}BL and ^{M}TR, which are significant points defined with respect to a coordinate system of the screen whose origin coincides with the centre of the screen S, these points being three of the four vertices of the focal plane in the present exemplary case.

The position of the observer's eyes, and consequently the position of the virtual cameras ^{M}C(n)^{L} and ^{M}C(n)^{R}, is calculated with respect to the screen, and is updated in the sampling time n.

In order to describe the focal plane with respect to the positions of the left and right virtual cameras, the following translations must be calculated:

T(n)^{L,R}=−_{M}C(n)^{L,R}

and these translations must be applied to the significant points ^{M}TL, ^{M}BL and ^{M}TR in order to calculate the variables ^{C}TL(n)^{L,R}, ^{C}BL(n)^{L,R} and ^{C}TR(n)^{L,R} which represent the coordinates of the significant points of the focal plane with respect to left and right camera's reference frames, according to the relations:

^{C}TL(n)^{L,R}=^{M}TL^{L,R}+T(n)^{L,R}

^{C}BL(n)^{L,R}=^{M}BL^{L,R}+T(n)^{L,R}

^{C}TR(n)^{L,R}=^{M}TR^{L,R}+T(n)^{L,R}

When the variables ^{C}TL(n)^{L,R}, ^{C}BL(n)^{L,R} and ^{C}TR(n)^{L,R} have been calculated, the generalized left and right asymmetric frustums are defined as a function of the time n.

When the three significant points of the projection screen have been reconstructed, the graphic engine of the processing station generates the projection of all the points inside the view volumes, using known projection formulae according to perspective projection methods which make use of a projection matrix.

In order to make explicit the projection matrix, it is necessary to define at least the quantities (^{C}ll(n)^{L,R}, ^{C}bb(n)^{L,R},- ^{C}dₙₑₐᵣ(n)^{L,R}) and (^{C}rr(n)^{L,R}, ^{C}tt(n)^{L,R},- ^{C}dₙₑₐᵣ(n)^{L,R}), which describe the coordinates of the bottom left and top right vertices of the plane N, or at least those of two points along the diagonal of the screen.

The variables ^{C}ll(n)^{L,R}, ^{C}bb(n)^{L,R}, ^{C}rr(n)^{L,R} and ^{C}tt(n)^{L,R} are calculated from the significant points ^{C}TR(n)^{L,R} and ^{C}BL(n)^{L,R} in the following manner:

$${{}^{C} ll ( n )}^{L , R} = {( \frac{{{}^{C} BL ( n )}^{L , R} {{}^{C} d ( n )}_{near}^{L , R}}{{{}^{C} d ( n )}_{focal}^{L , R}} )}_{x}$$

$${{}^{C} bb ( n )}^{L , R} = {( \frac{{{}^{C} BL ( n )}^{L , R} {{}^{C} d ( n )}_{near}^{L , R}}{{{}^{C} d ( n )}_{focal}^{L , R}} )}_{y}$$

$${{}^{C} rr ( n )}^{L , R} = {( \frac{{{}^{C} TR ( n )}^{L , R} {{}^{C} d ( n )}_{near}^{L , R}}{{{}^{C} d ( n )}_{focal}^{L , R}} )}_{x}$$

$${{}^{C} tt ( n )}^{L , R} = {( \frac{{{}^{C} TR ( n )}^{L , R} {{}^{C} d ( n )}_{near}^{L , R}}{{{}^{C} d ( n )}_{focal}^{L , R}} )}_{y}$$

The projection matrix M(n)^{L,R}_{projection} is therefore defined as follows:

$$( \begin{matrix}\frac{{2}^{C} {d ( n )}_{near}^{L , R}}{\begin{matrix}{{}^{C} rr ( n )}^{L , R} - \\ {{}^{C} ll ( n )}^{L , R}\end{matrix}} & 0 & \frac{\begin{matrix}{{}^{C} rr ( n )}^{L , R} + \\ {{}^{C} ll ( n )}^{L , R}\end{matrix}}{\begin{matrix}{{}^{C} rr ( n )}^{L , R} - \\ {{}^{C} ll ( n )}^{L , R}\end{matrix}} & 0 \\ 0 & \frac{{2}^{C} {d ( n )}_{near}^{L , R}}{\begin{matrix}{{}^{C} tt ( n )}^{L , R} - \\ {{}^{C} bb ( n )}^{L , R}\end{matrix}} & \frac{\begin{matrix}{{}^{C} tt ( n )}^{L , R} + \\ {{}^{C} bb ( n )}^{L , R}\end{matrix}}{\begin{matrix}{{}^{C} tt ( n )}^{L , R} - \\ {{}^{C} bb ( n )}^{L , R}\end{matrix}} & 0 \\ 0 & 0 & \frac{- ( \begin{matrix}{{}^{C} d ( n )}_{far}^{L , R} + \\ {{}^{C} d ( n )}_{near}^{L , R}\end{matrix} )}{\begin{matrix}{{}^{C} d ( n )}_{far}^{L , R} - \\ {{}^{C} d ( n )}_{near}^{L , R}\end{matrix}} & \frac{- {2}^{C} {d ( n )}_{far}^{L , R} {{}^{C} d ( n )}_{near}^{L , R}}{\begin{matrix}{{}^{C} d ( n )}_{far}^{L , R} - \\ {{}^{C} d ( n )}_{near}^{L , R}\end{matrix}} \\ 0 & 0 & - 1 & 0\end{matrix} )$$

where dₙₑₐᵣ, d_{far}, and d_{focal} denote, respectively, the distance of the near plane N, the far plane F and the focal plane P from a virtual camera position coinciding with the observation position C, and is applied to any point of the virtual scene so as to transform it into the clipping coordinates. A generic virtual point ^{C}T^{L,R}, expressed in homogenous coordinates, will therefore undergo the following transformation:

^{clip}T(n)^{L,R}=M(n)_{projection}^{L,R C}T^{L,R}

This transformation determines which objects are displayed and how they are displayed on the screen. In order to obtain the normalized device coordinates, a perspective division of the clipping coordinates is performed; in other words, the first three homogeneous coordinates are divided by the fourth. These normalized device coordinates are then scaled and translated to obtain the screen coordinates t(n)^{L} and t(n)^{R} of the image points corresponding to the object point.

The solution proposed by the invention is also applicable in the case of a projection screen which is not flat, by adapting the definition of the view volume in a corresponding manner.

With reference to FIGS. 9 and 10, an implementation and testing set-up according to the present invention is described.

In view of the availability of high-performance commercial products at affordable prices, it was considered preferable to use devices available on the market to develop an augmented reality system according to the solution proposed by the invention.

Specifically, the observer tracking device that was used was an X-Box Kinect, a movement detection device developed by Microsoft for the Xbox 360 games console. Based on an RGB camera and an infrared depth sensor, this device can provide information on the three-dimensional movement of a person's body. The depth sensor consists of an infrared projector combined with a monochrome camera which can capture video data in three dimensions in any environmental light conditions.

The main characteristics of the device are:
frame rate: 30 Hz;
size of the depth image: VGA (640×480);
depth resolution: 1 cm at a distance of 2 m from the sensor,
operating range: 0.6 m-3.5 m;
image sizes in the visible band: UXGA (1600×1200);
horizontal field of view: 580.

FIG. 9 shows the set-up diagram of the system. The Xbox Kinect 20 device was positioned on top of the screen S, centred on the axis X and slightly rotated about this axis. This configuration was chosen because it enabled the Kinect device to have a good view of the user, without being interposed between the user and the screen. In order to align the two coordinate systems, a calibration step was carried out, based on a set of environmental points whose coordinates were known with reference to the coordinate system of the monitor, by calculating the positions of these points derived from the Kinect sensor device.

The system is designed to detect and track the position of the body of the observer O in a preliminary start-up step. After the start-up step, whenever new observer position data are provided by the Kinect sensor, the processing station 10 is designed to recalculate the rendering of the three-dimensional virtual scenario by the following operations:

1. Measuring the position of the observer's eyes in the image plane of the RGB camera of the Kinect sensor, this can be done by tracking the position of the observer's head, starting from the detected position of the body and then executing a segmentation and recognition of each eye in the sub-image centred in the detected position of the head;
2. Calculating the position of the eyes in the real space in front of the display screen S, by combining their positions in the image plane of the RGB camera of the Kinect sensor and the corresponding depths obtained from the infrared detector of the Kinect sensor, with allowance for the spatial separation between the RGB and the infrared cameras;
3. Calculating and generating the generalized asymmetric view volumes according to the formulae described above, whenever the stereoscopic images are rendered on the screen.

In order to test the interaction of the observer with the system, the position of the observer's index finger was detected by means of a marker in the image plane of the RGB camera of the Kinect sensor. The three-dimensional position of the finger was computed by a procedure similar to that used to detect the position of the eyes.

In order to test and verify the efficacy of the rendering system proposed by the invention, the following experiment was conducted (FIG. 10).

The observer was asked to touch a virtual target D, for example the nearerst bottom right vertex of a cube E rendered frontally in the virtual environment, with a width of 2.5 cm. The scene was observed from different positions and orientations assumed by the observer in an area of free movement A with respect to the display screen, and the positions of the eyes and the index finger of the observer were acquired. The experiment was conducted using a standard rendering method for comparison with the rendering solution proposed by the invention. Different subjects were selected in advance for the performance of the experiments, each subject carrying out his task while observing the scene from different positions and orientations.

The use of the system proposed by the invention resulted in a considerable reduction of the error in the perceived position of the target and the standard deviation of the error.

The table below shows the mean errors and their standard deviations for the perceived

| | Y | X | Z |
|---|---|---|---|
| Prior art | 22 ± 16 | 81 ± 68 | 146 ± 119 |
| Invention | 20 ± 4 | 5 ± 3 | 12 ± 8 |

A scale drawing of the areas of the perceived points with respect to the observer's movements in a predetermined area A in the two situations is shown in FIG. 10. It can be seen that the positions of the target D perceived in the system according to the invention (area B) are less widely distributed than the positions of the target perceived using a prior art system (area C). These results confirm that the system according to the invention provides better and more accurate perception of the depth and structure of a virtual reality scene.

It has thus been demonstrated that the solution proposed by the invention can significantly improve stereoscopic three-dimensional rendering applications.

These improvements may be extremely useful for the correct representation of virtual reality or augmented reality scenarios, both in the scientific field, for example in rehabilitation applications, psychophysical experiments, the human-machine interface, scientific display systems, simulators, and remote medicine and remote operation applications, and in the entertainment sector, for example in three-dimensional television rendering and for rendering video games environments.

Naturally, the principle of the invention remaining the same, the forms of embodiment and details of construction may be varied widely with respect to those described and illustrated, which have been given purely by way of non-limiting example, without thereby departing from the scope of protection of the present invention as defined by the attached claims.

1. System for three-dimensional stereoscopic rendering of virtual objects without distortion in a virtual or augmented reality scenario by a display screen with respect to which an observer can move and/or change his/her position and/or the orientation of his/her head and consequently a position of his/her eyes, including processing means adapted for generating, for each virtual object point defined in a three-dimensional coordinate system, a pair of corresponding image points on said screen which are selectively visible to the observer, comprising:
means for tracking an observer, adapted to detect the coordinates of a respective observation position in a predetermined reference system related to the screen;
wherein said processing means are arranged to generate, for each virtual object point defined in a three-dimensional coordinate system, a pair of corresponding image points on said screen as a function of the position of the eyes of the observer in a detected current observation position.

2. System according to claim 1, wherein said processing means are arranged to compute, over time, pairs of generalized asymmetric view volumes which originate from a current positions of the observer's eyes and having focal planes coinciding with the display screen.

3. System according to claim 2, wherein said processing means are arranged to compute said pair of view volumes periodically, or as a consequence of an event in the form of a movement of the observer or of the position of his/her eyes.

4. System according to claim 2, wherein each generalized asymmetric view volume is defined by a respective observation position and by significant points representing vertices of a focal plane coinciding with the display screen in a predetermined reference system which is related to the observation position by the relations
^{C}TL(n)^{L,R}=^{M}TL^{L,R}+T(n)^{L,R}
^{C}BL(n)^{L,R}=^{M}BL^{L,R}+T(n)^{L,R}
^{C}TR(n)^{L,R}=^{M}TR^{L,R}+T(n)^{L,R}
where ^{M}TL, ^{M}BL and ^{M}TR are significant points of the focal plane coinciding with the display screen in a first coordinate system referred to the screen, ^{C}TL(n)^{L,R}, ^{C}BL(n)^{L,R} and ^{C}BR(n)^{L,R} represent the coordinates of said significant points in a second coordinate system referred to the observation positions coinciding with the origin of the view volumes, which evolve in a sampling time n, and T(n)^{L,R}=−^{M}C(n)^{L,R} is a translation between the first and the second coordinate system,
and said processing means are arranged to generate said pair of corresponding image points from the current coordinates of said significant points by applying a projection matrix, M(n)^{L,R}_{projection}.

5. System according to claim 4, wherein said projection matrix M(n)^{L,R}_{projection} is defined as follows:
$$( \begin{matrix}\frac{{2}^{C} {d ( n )}_{near}^{L , R}}{\begin{matrix}{{}^{C} rr ( n )}^{L , R} - \\ {{}^{C} ll ( n )}^{L , R}\end{matrix}} & 0 & \frac{\begin{matrix}{{}^{C} rr ( n )}^{L , R} + \\ {{}^{C} ll ( n )}^{L , R}\end{matrix}}{\begin{matrix}{{}^{C} rr ( n )}^{L , R} - \\ {{}^{C} ll ( n )}^{L , R}\end{matrix}} & 0 \\ 0 & \frac{{2}^{C} {d ( n )}_{near}^{L , R}}{\begin{matrix}{{}^{C} tt ( n )}^{L , R} - \\ {{}^{C} bb ( n )}^{L , R}\end{matrix}} & \frac{\begin{matrix}{{}^{C} tt ( n )}^{L , R} + \\ {{}^{C} bb ( n )}^{L , R}\end{matrix}}{\begin{matrix}{{}^{C} tt ( n )}^{L , R} - \\ {{}^{C} bb ( n )}^{L , R}\end{matrix}} & 0 \\ 0 & 0 & \frac{- ( \begin{matrix}{{}^{C} d ( n )}_{far}^{L , R} + \\ {{}^{C} d ( n )}_{near}^{L , R}\end{matrix} )}{\begin{matrix}{{}^{C} d ( n )}_{far}^{L , R} - \\ {{}^{C} d ( n )}_{near}^{L , R}\end{matrix}} & \frac{- {2}^{C} {d ( n )}_{far}^{L , R} {{}^{C} d ( n )}_{near}^{L , R}}{\begin{matrix}{{}^{C} d ( n )}_{far}^{L , R} - \\ {{}^{C} d ( n )}_{near}^{L , R}\end{matrix}} \\ 0 & 0 & - 1 & 0\end{matrix} ) \\ where \\ {{}^{C} ll ( n )}^{L , R} = {( \frac{{{}^{C} BL ( n )}^{L , R} {{}^{C} d ( n )}_{near}^{L , R}}{{{}^{C} d ( n )}_{focal}^{L , R}} )}_{x} \\ {{}^{C} bb ( n )}^{L , R} = {( \frac{{{}^{C} BL ( n )}^{L , R} {{}^{C} d ( n )}_{near}^{L , R}}{{{}^{C} d ( n )}_{focal}^{L , R}} )}_{y} \\ {{}^{C} rr ( n )}^{L , R} = {( \frac{{{}^{C} TR ( n )}^{L , R} {{}^{C} d ( n )}_{near}^{L , R}}{{{}^{C} d ( n )}_{focal}^{L , R}} )}_{x} \\ {{}^{C} tt ( n )}^{L , R} = {( \frac{{{}^{C} TR ( n )}^{L , R} {{}^{C} d ( n )}_{near}^{L , R}}{{{}^{C} d ( n )}_{focal}^{L , R}} )}_{y}$$
and dₙₑₐᵣ, d_{far}, and d_{focal} denote, respectively, the distance of the near plane, the far plane and the focal plane from a virtual camera position coinciding with the observation position,
the projection matrix being applied to points of a virtual scene expressed in homogeneous coordinates, ^{C}T^{L,R}, so as to transform the points into clipping coordinates by the transformation
^{clip}T(n)^{L,R}=M(n)_{projection}^{L,R C}T^{L,R}
said clipping coordinates being subjected to perspective division in order to provide normalized device coordinates representing the screen coordinates, t(n)^{L,R}, t(n)^{R}, of the image points corresponding to the object point.

6. Method for three-dimensional stereoscopic rendering of virtual objects without distortion in a scenario by a display screen with respect to which an observer can move and/or change a direction of observation and consequently position of his/her eyes, comprising:
tracking an observer, and detecting coordinates of a respective observation position in a predetermined reference system related to the screen, and
generating, for each object point, a pair of corresponding image points on said screen, which are selectively visible to the observer, as a function of the position of the eyes of the observer in a detected current observation position.

7. Method according to claim 6, comprising computing, over time, pairs of generalized asymmetric view volumes which originate from current positions of the observer's eyes and have focal planes coinciding with the display screen.

8. Method according to claim 7, comprising computing a pair of view volumes periodically, or as a consequence of an event comprising a movement of the observer or of the position of his/her eyes.

9. Method according to claim 7, wherein each generalized asymmetric view volume is defined by a respective observation position and by significant points representing vertices of the focal plane coinciding with the display screen in a predetermined reference system which is related to the observation position by the relations
^{C}TL(n)^{L,R}=^{M}TL^{L,R}+T(n)^{L,R}
^{C}BL(n)^{L,R}=^{M}BL^{L,R}+T(n)^{L,R}
^{C}TR(n)^{L,R}=^{M}TR^{L,R}+T(n)^{L,R}
where ^{M}TL, ^{M}BL and ^{M}TR are significant points of the focal plane coinciding with the display screen in a first coordinate system referred to the screen, ^{C}TL(n)^{L,R}, ^{C}BL(n)^{L,R} and ^{C}BR(n)^{L,R} represent coordinates of said significant points in a second coordinate system referred to the observation positions coinciding with an origin of the view volumes, which evolve in a sampling time n, and T(n)^{L,R}=−^{M}C(n)^{L,R} is a translation between the first and the second coordinate system,
the method comprising generating a pair of corresponding image points from current coordinates of said significant points by applying a projection matrix, M(n)^{L,R}_{projection}.

10. Method according to claim 9, wherein said projection matrix M(n)^{L,R}_{projection} is defined as follows:
$$( \begin{matrix}\frac{{2}^{C} {d ( n )}_{near}^{L , R}}{\begin{matrix}{{}^{C} rr ( n )}^{L , R} - \\ {{}^{C} ll ( n )}^{L , R}\end{matrix}} & 0 & \frac{\begin{matrix}{{}^{C} rr ( n )}^{L , R} + \\ {{}^{C} ll ( n )}^{L , R}\end{matrix}}{\begin{matrix}{{}^{C} rr ( n )}^{L , R} - \\ {{}^{C} ll ( n )}^{L , R}\end{matrix}} & 0 \\ 0 & \frac{{2}^{C} {d ( n )}_{near}^{L , R}}{\begin{matrix}{{}^{C} tt ( n )}^{L , R} - \\ {{}^{C} bb ( n )}^{L , R}\end{matrix}} & \frac{\begin{matrix}{{}^{C} tt ( n )}^{L , R} + \\ {{}^{C} bb ( n )}^{L , R}\end{matrix}}{\begin{matrix}{{}^{C} tt ( n )}^{L , R} - \\ {{}^{C} bb ( n )}^{L , R}\end{matrix}} & 0 \\ 0 & 0 & \frac{- ( \begin{matrix}{{}^{C} d ( n )}_{far}^{L , R} + \\ {{}^{C} d ( n )}_{near}^{L , R}\end{matrix} )}{\begin{matrix}{{}^{C} d ( n )}_{far}^{L , R} - \\ {{}^{C} d ( n )}_{near}^{L , R}\end{matrix}} & \frac{- {2}^{C} {d ( n )}_{far}^{L , R} {{}^{C} d ( n )}_{near}^{L , R}}{\begin{matrix}{{}^{C} d ( n )}_{far}^{L , R} - \\ {{}^{C} d ( n )}_{near}^{L , R}\end{matrix}} \\ 0 & 0 & - 1 & 0\end{matrix} ) \\ where \\ {{}^{C} ll ( n )}^{L , R} = {( \frac{{{}^{C} BL ( n )}^{L , R} {{}^{C} d ( n )}_{near}^{L , R}}{{{}^{C} d ( n )}_{focal}^{L , R}} )}_{x} \\ {{}^{C} bb ( n )}^{L , R} = {( \frac{{{}^{C} BL ( n )}^{L , R} {{}^{C} d ( n )}_{near}^{L , R}}{{{}^{C} d ( n )}_{focal}^{L , R}} )}_{y} \\ {{}^{C} rr ( n )}^{L , R} = {( \frac{{{}^{C} TR ( n )}^{L , R} {{}^{C} d ( n )}_{near}^{L , R}}{{{}^{C} d ( n )}_{focal}^{L , R}} )}_{x} \\ {{}^{C} tt ( n )}^{L , R} = {( \frac{{{}^{C} TR ( n )}^{L , R} {{}^{C} d ( n )}_{near}^{L , R}}{{{}^{C} d ( n )}_{focal}^{L , R}} )}_{y}$$
and dₙₑₐᵣ, d_{far}, and d_{focal} denote, respectively, a distance of a near plane, a far plane and the focal plane from a virtual camera position coinciding with the observation position,
the projection matrix being applied to the points of a virtual scene expressed in homogeneous coordinates, ^{C}T^{L,R}, so as to transform the points into clipping coordinates by the transformation
^{clip}T(n)^{L,R}=M(n)_{projection}^{L,R C}T^{L,R}
said clipping coordinates being subjected to perspective division in order to provide normalized device coordinates representing the screen coordinates, t(n)^{L}, t(n)^{R}, of the image points corresponding to the object point.

11. Computer program or group of programs executable by a processing system, comprising one or more code modules for implementing a method for the three-dimensional stereoscopic rendering of virtual objects according to

12. Computer program product storing a computer program or group of programs according to claim 11.
